(19) United States
(12) Patent Application Publication
(10) Pub. No.: US 2026/0192820 A1
(43) Pub. Date: Jul. 9, 2026

(54) DECENTRALIZED POWER GENERATION AND TRANSMISSION IN A VEHICLE

(71) Applicant: International Business Machines Corporation, Armonk, NY (US)

(72) Inventors: Tushar Agrawal, West Fargo, ND (US); Jeremy R. Fox, Georgetown, TX (US); Martin G. Keen, Cary, NC (US); Sarbajit Kumar Rakshit, Kolkata (IN)

(21) Appl. No.: 19/010,264

(22) Filed: Jan. 6, 2025

(51) Int. Cl. B60W 60/00; B60W 20/14; B60W 30/18; H02J 50/12

(52) U.S. Cl. CPC B60W 60/001; B60W 20/14; B60W 30/18127; H02J 50/12; H02J 2105/37

(57) ABSTRACT

Examples described herein provide systems and methods for decentralized power generation and transmission for a vehicle with robotic wheel assemblies, each having an electronic control system and a wheel. Aspects include receiving an operational command, identifying a desired wheel movement, transmitting power wirelessly from a vehicle battery to the robotic wheel assemblies, transmitting a command to the electronic control system to perform the desired movement, and monitoring the movement of the vehicle via sensors.

### BACKGROUND

The disclosure generally relates to vehicle propulsion technologies, specifically to decentralized power generation and transmission systems utilizing robotic wheels with electronic control systems and wireless power transfer.

Electric vehicles (EVs) differ significantly from conventional vehicles, particularly in the drivetrain. Most EVs utilize a single-speed mechanism to regulate the system, which can operate beyond 10,000 rotations per minute (RPM) with ease. This contrasts with the 6,000 RPM redline of many internal combustion engines. The consistent torque produced by systems across a wide RPM range eliminates the need for multi-speed mechanisms, which would otherwise add weight and increase production costs.

The traditional centralized drivetrain system used in electric vehicles presents several challenges, including weight penalties, reduced range, and limited scalability. These drivetrain systems are often bulky, expensive, and difficult to maintain. There is a growing need for a more efficient, lightweight, and cost-effective solution that can address these issues while enhancing the overall performance of electric vehicles.

### SUMMARY

According to one aspect of the present invention, a computer-implemented method for providing decentralized power generation and transmission for a vehicle having a plurality of robotic wheel assemblies, each robotic wheel assembly comprising an electronic control system and a wheel. The method includes receiving an operational command for the vehicle, identifying a desired movement of the wheel of one or more of the plurality of robotic wheel assemblies, and transmitting power, via a wireless power transmission system, from a vehicle battery to each of the one or more of the plurality of robotic wheel assemblies. The method also includes transmitting a command to an electronic control system of the one or more of the plurality of robotic wheel assemblies to instruct the electronic control system to perform the desired movement and monitoring, via one or more sensors, a movement of the vehicle.

The above features and advantages, and other features and advantages, of the disclosure, are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a vehicle according to one or more embodiments;

FIG. 3 illustrates a block diagram of a vehicle having a decentralized power generation and transmission system according to one or more embodiments; and

FIG. 4 illustrates a flowchart diagram of a method for decentralized power generation and transmission for a vehicle according to one or more embodiments.

The detailed description explains embodiments of the disclosure, together with advantages and features, by way of example with reference to the drawings.

### DETAILED DESCRIPTION

The traditional centralized power generation and transmission system used in autonomous vehicles poses several challenges. These systems often result in weight penalties, reduced range, and limited scalability. Additionally, centralized systems are typically bulky, expensive, and difficult to maintain. These issues hinder the overall performance and efficiency of autonomous vehicles, creating a need for more efficient, lightweight, and cost-effective solutions.

Existing solutions in the field of autonomous vehicle power systems have several disadvantages. Centralized power systems add significant weight to the vehicle, which negatively impacts the vehicle's range and efficiency. The bulkiness of these systems also limits the design flexibility and scalability of the vehicle. Furthermore, the high costs associated with centralized power systems, including production and maintenance expenses, make them less economically viable. These drawbacks highlight the need for an innovative approach to power generation and transmission in autonomous vehicles.

The disclosed system addresses these challenges by providing a novel approach to power generation and transmission in autonomous vehicles. The system leverages wireless power transfer and swarm robotics to eliminate the need for centralized power systems, thereby reducing weight and increasing range. By decentralizing power generation and transmission, the system enables more efficient and cost-effective autonomous vehicle design. Each robotic wheel is equipped with an electronic control system and power transmission system, allowing the robotic wheel to rotate independently and synchronize movements with other robotic wheels. The wheels wirelessly receive power from the vehicle battery, and each vehicle has an identifier that is validated by the vehicle battery before transmitting power to individual batteries. Edge computing ecosystems enable the robotic wheels to collaborate and communicate with each other, resulting in enhanced intelligent and responsive driving experiences.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

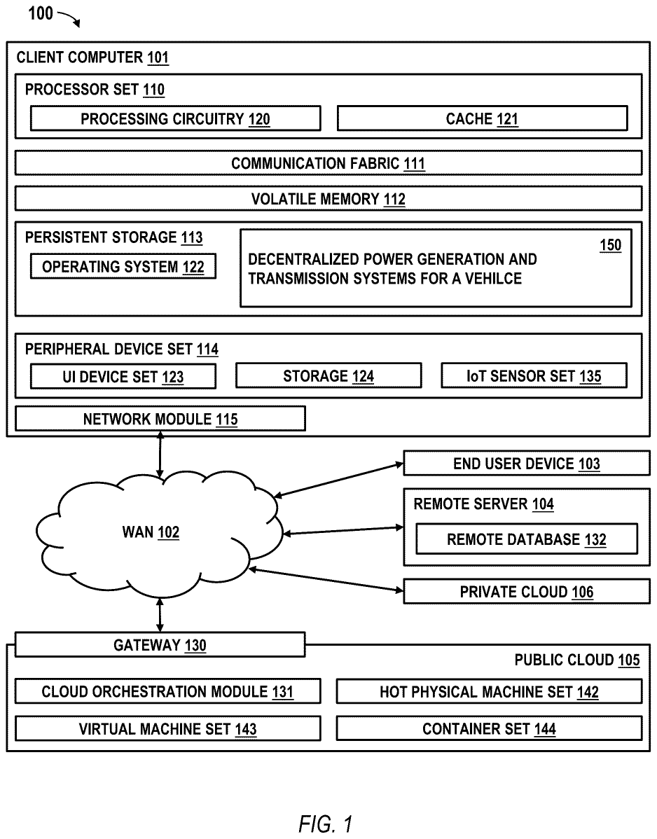

FIG. 1 illustrates a computing environment 100, according to an embodiment. Computing environment 100 contains an example of an environment for the execution of at least some of the computer code includes providing decentralized power generation and transmission for a vehicle, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 135), and network module 115. Remote server 104 includes remote database 132. Public cloud 105 includes gateway 130, cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

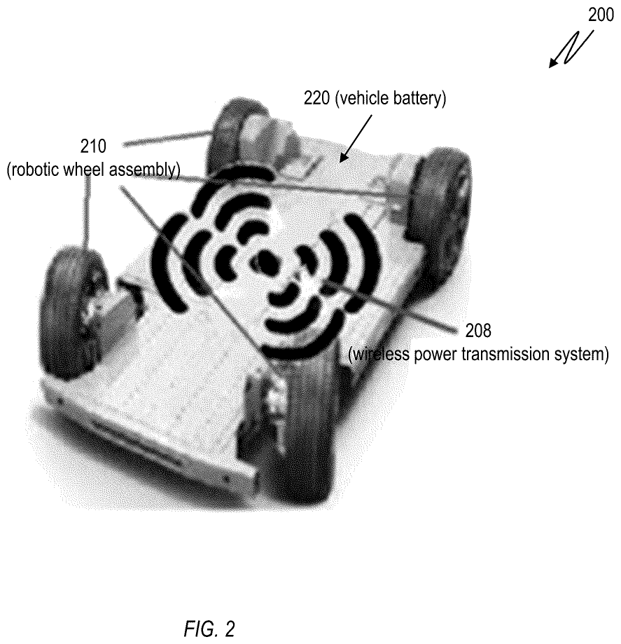

FIG. 2 illustrates a block diagram of a vehicle 200 according to one or more embodiments. The vehicle 200 includes four robotic wheel assemblies 210, a wireless power transmission system 208, and a vehicle battery 220.

In exemplary embodiments, the robotic wheel assembly 210 is integrated into the vehicle 200 to provide propulsion and maneuverability. The robotic wheel assembly 210 includes electronic control systems that manage the wheel's operations, ensuring efficient power usage and precise control. The robotic wheel assembly 210 interacts with the wireless power transmission system 208 to receive power wirelessly, eliminating the need for physical connections and enhancing the vehicle's flexibility and efficiency.

In exemplary embodiments, the wireless power transmission system 208 is responsible for transmitting power wirelessly to the robotic wheel assembly 210. The wireless power transmission system 208 utilizes electromagnetic fields to transfer energy from the vehicle battery 220 to the robotic wheel assembly 210. The wireless power transmission system 208 ensures continuous power supply to the wheels, enabling the vehicle 200 to operate without interruptions due to power transmission issues.

In exemplary embodiments, the vehicle battery 220 stores the electrical energy required for the operation of the vehicle 200. The vehicle battery 220 supplies power to the wireless power transmission system 208, which then wirelessly transmits this power to the robotic wheel assembly 210. The efficient energy storage and transmission system provided by the vehicle battery 220 and wireless power transmission system 208 ensures that the vehicle 200 can maintain optimal performance over extended periods.

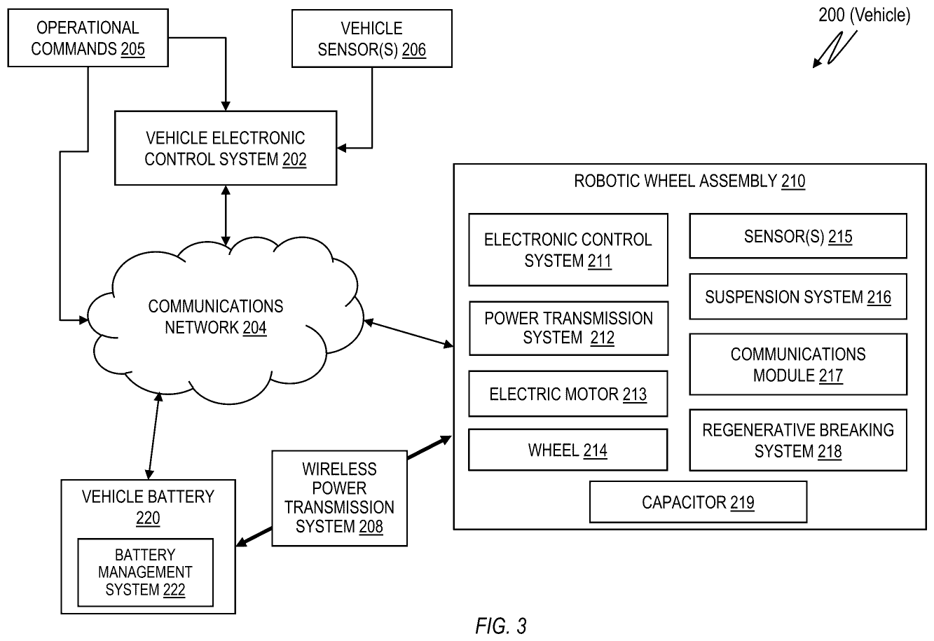

Referring now to FIG. 3, a block diagram of a vehicle having a decentralized power generation and transmission system according to one or more embodiments is shown.

In exemplary embodiments, the vehicle 200 includes several components that work together to enable decentralized power generation and transmission. These components include, but are not limited to, the vehicle electronic control system 202, communications network 204, vehicle sensor(s) 206, wireless power transmission system 208, robotic wheel assembly 210, electric motor 213, wheels 214, sensor(s) 215, suspension system 216, communications module 217, regenerative braking system 218, capacitor 219, vehicle battery 220, and battery management system 222.

In exemplary embodiments, the vehicle electronic control system 202 manages the overall operation of the vehicle 200. The vehicle electronic control system 202 system receives input from various sensors and components, processes this data, and sends control signals to other systems within the vehicle 200. In exemplary embodiments, the vehicle electronic control system 202 is configured to receive operational commands 205, either from a user interface (not shown) or via a communications network 204. The operational commands 205 are the instructions sent to the vehicle electronic control system 202 to control the operation of the vehicle 200. The vehicle electronic control system 202 is configured to generate and transmit instructions to various components and systems of the vehicle based on the received operational commands 205. For example, the instructions may be used to adjust the speed and direction of the wheels or manage power distribution. The vehicle electronic control system 202 ensures that the vehicle operates efficiently and responds appropriately to changing conditions and commands.

In exemplary embodiments, the communications network 204 facilitates data exchange between different components of the vehicle 200, and optionally between the vehicle 200 and external systems. The communications network 204 enables the vehicle electronic control system 202 to communicate with other systems, such as the wireless power transmission system 208 and the robotic wheel assembly 210. In exemplary embodiments, the communications network 204 is a secure network that employs a high level of data encryption to ensure the integrity and confidentiality of the data being transmitted. This secure communication enhances the overall reliability and safety of the operations of the vehicle 200.

In exemplary embodiments, the vehicle sensor(s) 206 are configured to provide real-time data about the environment and operating conditions of the vehicle 200. The vehicle sensors 206 include accelerometers, gyroscopes, and position sensors, which supply input to the vehicle electronic control system 202. The data from vehicle sensor(s) 206 is used to make informed decisions about the vehicle's operation, ensuring safety and efficiency.

In exemplary embodiments, the wireless power transmission system 208 is responsible for transmitting power wirelessly from the vehicle battery 220 to the robotic wheel assembly 210. The wireless power transmission system 208 system uses technologies such as inductive coupling or magnetic resonance to transfer energy without physical connections. The wireless power transmission system 208 is designed to operate over a short transmission range, ensuring efficient and targeted power delivery to the robotic wheel assembly 210. This short transmission range minimizes energy loss and maximizes the power transmission rate, allowing for a high-power transmission rate that ensures the wheels receive sufficient energy for optimal performance. The wireless power transmission system 208 continuously monitors and adjusts the power transmission to maintain a stable and efficient energy supply, enabling the vehicle 200 to operate smoothly and reliably.

In exemplary embodiments, the robotic wheel assembly 210 includes several components that work together to propel the vehicle 200. Each robotic wheel assembly 210 has a separate electronic control system 211 and power transmission system 212, allowing the robotic wheel assembly 210 to rotate independently. If desired, the independent electronic control system 211 and power transmission system 212 can be used to synchronize the robotic wheel assembly 210 movements with other wheels of the vehicle 200. The robotic wheel assembly 210 receives power wirelessly from the wireless power transmission system 208 and uses this power to control the rotation speed and direction of the wheel 214.

In exemplary embodiments, the electric motor 213 within the robotic wheel assembly 210 converts electrical energy into mechanical energy to drive the wheel 214. The electric motor 213 is controlled by the electronic control system 211, which adjusts the operation of the electric motor 213 based on input from sensors 215 and commands from the vehicle electronic control system 202.

In exemplary embodiments, the wheel 214 is the primary component that makes contact with the ground and provides traction for the vehicle 200. The rotation and movement of the wheel 214 are controlled by the electric motor 213 and the electronic control system 211, ensuring precise maneuverability and propulsion.

In exemplary embodiments, the sensor(s) 215 within the robotic wheel assembly 210 provide data about the wheel's position, speed, and other parameters. These sensors 215 supply input to the electronic control system 211, enabling accurate control of the wheel's movements.

In exemplary embodiments, the suspension system 216 supports the vehicle 200 and absorbs shocks from the road surface. The suspension system 216 ensures a smooth ride by maintaining contact between the wheels 214 and the ground, even on uneven terrain. The suspension system 216 works in conjunction with the robotic wheel assembly 210 to enhance the vehicle's performance and comfort. In one embodiment, the suspension system 216 includes an adaptive component, such as a magnetorheological damper, that is controlled by the electronic control system 211. The magnetorheological damper can adjust its damping characteristics in real-time based on input from the electronic control system 211, which processes data from various sensors 215. This adaptive suspension system allows for dynamic adjustments to the ride quality and handling of the vehicle 200, providing optimal performance and comfort under varying driving conditions.

In exemplary embodiments, the communications module 217 within the robotic wheel assembly 210 enables data exchange between the electronic control system 211 and other components of the vehicle 200. The communications module 217 uses wireless communication protocols such as Wi-Fi, Bluetooth, or cellular networks to facilitate seamless integration and coordination. The communications module 217 ensures that the robotic wheel assembly 210 can collaborate with the electronic control system 211 and/or other robotic wheel assemblies 210 and systems in the vehicle 200.

In exemplary embodiments, the regenerative braking system 218 captures kinetic energy during braking and converts the kinetic energy into electrical energy. The captured energy may be stored in the capacitor 219 or transmitted to the vehicle battery 220 via the wireless power transmission system 208. The regenerative braking system 218 enhances the energy efficiency of the vehicle 200 by recovering energy that would otherwise be lost as heat.

In exemplary embodiments, the capacitor 219 stores electrical energy that is either generated by the regenerative braking system 218 or received from the wireless power transmission system 208. This stored energy can be used to power the electric motor 213 or other components of the vehicle 200, reducing the load on the vehicle battery 220. The capacitor 219 helps to improve the overall energy efficiency of the vehicle. Additionally, the capacitor 219 can provide extra power during periods of high-power demand by the electric motor 213. For instance, during rapid acceleration or when climbing steep inclines, the electric motor 213 may require more power than what the vehicle battery 220 can supply alone. In such scenarios, the capacitor 219 can discharge its stored energy to supplement the power from the vehicle battery 220, ensuring that the electric motor 213 receives sufficient power to maintain optimal performance.

In exemplary embodiments, the vehicle battery 220 is the primary energy source for the vehicle 200. The vehicle battery 220 stores electrical energy and supplies power to the wireless power transmission system 208, which then transmits this power to the robotic wheel assembly 210. The vehicle battery 220 ensures that the vehicle has a reliable and consistent power supply for the operation of the vehicle 200.

In exemplary embodiments, the battery management system 222 manages the power supply to the vehicle 200 and the individual robotic wheel assemblies 210. The battery management system 222 monitors the voltage and current transmission of the vehicle battery 220, ensuring accurate and efficient power distribution. The battery management system 222 works in conjunction with the vehicle electronic control system 202 to optimize the vehicle's energy usage and maintain optimal performance.

In exemplary embodiments, the wireless power transmission system 208 and/or the power transmission system 212 may include power electronics and conversion components, such as DC-DC converters or inverters, to optimize power efficiency and minimize energy loss. Furthermore, the wireless power transmission system 208 and/or the power transmission system 212 may include sensing and feedback mechanisms, including current sensors and voltage sensors, to monitor the power transmission process and ensure accurate and efficient power supply.

In exemplary embodiments, the wireless power transmission system 208 and/or the power transmission system 212 may include advanced power electronics and conversion components, such as DC-DC converters or inverters, to optimize power efficiency and minimize energy loss. These components are used to convert the electrical energy from the vehicle battery 220 into a form that can be efficiently transmitted wirelessly to the robotic wheel assemblies 210. The DC-DC converters are used to step up or down the voltage levels as required, ensuring that the power delivered to the robotic wheel assemblies is at the optimal voltage for their operation. Inverters are used to convert direct current (DC) from the battery into alternating current (AC) if needed, depending on the design of the wireless power transmission system.

Furthermore, the wireless power transmission system 208 and/or the power transmission system 212 may include sophisticated sensing and feedback mechanisms to monitor the power transmission process and ensure accurate and efficient power supply. These mechanisms include current sensors and voltage sensors that continuously measure the electrical parameters of the power being transmitted. The data collected by these sensors is fed back to the control systems, which use it to make real-time adjustments to the power transmission process. For example, if the sensors detect a voltage drop or an increase in current that could indicate a potential issue, the control system can adjust the power output to compensate and maintain a stable and efficient power supply.

Additionally, the sensing and feedback mechanisms can be used to detect and diagnose faults in the power transmission system. By continuously monitoring the electrical parameters, the system can identify anomalies that may indicate a malfunction or degradation in the components. This allows for proactive maintenance and repair, reducing the risk of unexpected failures and ensuring the reliability of the vehicle's power system. The integration of these advanced power electronics and sensing mechanisms ensures that the wireless power transmission system 208 and the power transmission system 212 operate at peak efficiency, providing a reliable and efficient power supply to the robotic wheel assemblies 210.

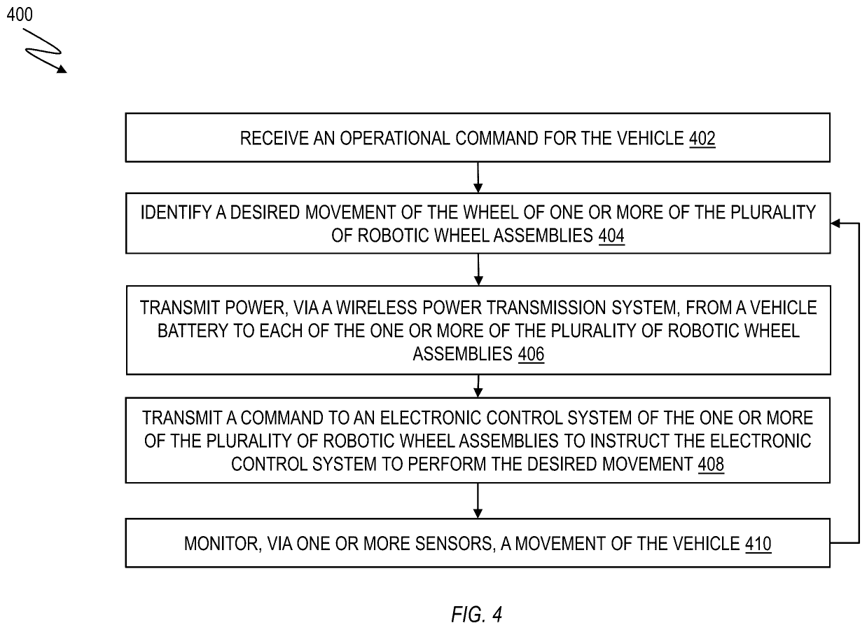

Referring now to FIG. 4, a flowchart diagram of a method 400 for decentralized power generation and transmission for a vehicle is shown. In exemplary embodiments, the method 400 is performed by the vehicle electronic control system 202 shown in FIG. 3. The method 400 begins at block 402 by receiving an operational command for the vehicle. In exemplary embodiments, the vehicle electronic control system 202 is configured to receive operational commands 205, either from a user interface or via a communications network 204. The operational commands 205 are the instructions sent to the vehicle electronic control system 202 to control the operation of the vehicle 200. The vehicle electronic control system 202 processes these commands and generates instructions for various components and systems within the vehicle 200.

Next, as shown at block 404, the method 400 includes identifying a desired movement of the wheel of one or more of the plurality of robotic wheel assemblies. In exemplary embodiments, the vehicle electronic control system 202 analyzes the operational commands 205 and determines the specific movements required for the robotic wheel assemblies 210. This step ensures that the vehicle 200 can perform the desired maneuvers accurately and efficiently.

The method 400 then proceeds to block 406 and includes transmitting power, via a wireless power transmission system, from a vehicle battery to each of the plurality of robotic wheel assemblies. The wireless power transmission system 208 is responsible for transmitting power wirelessly from the vehicle battery 220 to the robotic wheel assembly 210. The wireless power transmission system 208 utilizes technologies such as inductive coupling or magnetic resonance to transfer energy without physical connections. The wireless power transmission system 208 ensures continuous power supply to the wheels, enabling the vehicle 200 to operate without interruptions due to power transmission issues.

Following the power transmission, the method 400 includes transmitting a command to an electronic control system of the plurality of robotic wheel assemblies to instruct the electronic control system to perform the desired movement, as shown at block 408. In exemplary embodiments, the electronic control system 211 within each robotic wheel assembly 210 receives these commands and adjusts the operation of the electric motor 213 accordingly. This step ensures that the wheels 214 rotate at the desired speed and direction, providing precise control and maneuverability for the vehicle 200.

The method 400 concludes at block 410 by monitoring, via one or more sensors, the movement of the vehicle. The vehicle sensor(s) 206, including accelerometers, gyroscopes, and position sensors, provide real-time data about the environment and operating conditions of the vehicle 200. This data is used by the vehicle electronic control system 202 to make informed decisions about the operation of the vehicle 200. In exemplary embodiments, the sensors 215 within the robotic wheel assembly 210 also provide data about the position, speed, and other parameters of the wheel 214, enabling accurate control of the movements of the wheel 214.

In exemplary embodiments, the method 400 ensures that the vehicle 200 operates efficiently and responds appropriately to changing conditions and commands. By decentralizing power generation and transmission, the system enables more efficient and cost-effective autonomous vehicle design. The electronic control system 211 of each robotic wheel assembly 210 is configured to adjust the rotation speed and direction of the wheel based on the received command. The sensors used to monitor the movement of the vehicle include accelerometers, gyroscopes, and position sensors.

In exemplary embodiments, the vehicle electronic control system 202 is configured to validate an identifier of each robotic wheel assembly 210 before transmitting power or instructions to the robotic wheel assembly 210. This validation process ensures that only authorized and correctly functioning wheel assemblies receive power, enhancing the security and reliability of the system. The vehicle electronic control system 202 can be configured to use various wireless communication protocols, such as Wi-Fi, Bluetooth, or cellular networks, to perform the validation process. In another embodiment, the vehicle electronic control system 202 incorporates advanced encryption techniques to secure the communication between the vehicle battery and the robotic wheel assemblies, preventing unauthorized access and potential cyber threats. Additionally, the vehicle electronic control system 202 be designed to support multiple types of identifiers, such as IDs, RFID tags, or digital certificates, providing flexibility in the implementation of the validation process. In yet another embodiment, the vehicle electronic control system 202 includes a real-time monitoring system that continuously checks the status of each robotic wheel assembly 210, ensuring that any issues are detected and addressed promptly. This monitoring system can utilize various sensors, including voltage and current sensors, to gather data on the power transmission process and ensure accurate and efficient power supply.

In exemplary embodiments, the electronic control system 211 of each robotic wheel assembly 210 incorporates machine-learning algorithms that are designed to optimize control based on real-time data and feedback from various sensors 215. These sensors 215 may include accelerometers, gyroscopes, and position sensors, which provide continuous input regarding the wheel's position, speed, and other operational parameters. The machine learning algorithms can adapt to different driving conditions by analyzing historical data and making predictive adjustments to the wheel's rotation speed and direction, thereby enhancing the overall performance and efficiency of the vehicle.

In exemplary embodiments, the electronic control system 211 may utilize a combination of model predictive control (MPC) and proportional-derivative (PID) control techniques to achieve precise maneuverability. The MPC can predict future states of the vehicle based on current sensor data and adjust the control inputs accordingly, while the PID control can fine-tune the wheel movements to maintain stability and responsiveness.

In exemplary embodiments, the vehicle 200 can be used for a variety of types of vehicles, such as autonomous delivery vehicles, autonomous passenger vehicles, conventional passenger vehicles, and autonomous agricultural robots. In the case of an autonomous delivery vehicle, the vehicle 200 is configured to navigate through various environments and situations, such as busy city streets or rural areas, to deliver goods efficiently. Each robotic wheel assembly 210 can adjust its speed and direction based on driving parameters, allowing for precise maneuverability and efficient delivery of goods. The decentralized power generation and transmission system ensures that the vehicle 200 operates smoothly and reliably, reducing the need for frequent maintenance and increasing the overall efficiency of the delivery process.

For an autonomous passenger vehicle, the vehicle 200 is designed to transport people safely and comfortably through urban and suburban areas, adjusting its speed and direction based on real-time traffic conditions and passenger preferences. The adaptive suspension system, including components such as magnetorheological dampers, ensures a smooth and comfortable ride by adjusting to varying road conditions in real-time. The decentralized power generation and transmission system enhances the vehicle's energy efficiency, allowing for longer trips without the need for frequent recharging.

As a conventional passenger vehicle, the vehicle 200 can be driven manually by a human driver, with the electronic control system 202 providing assistance for tasks such as maintaining optimal speed and direction. The regenerative braking system captures kinetic energy during braking and converts it into electrical energy, which is stored in the capacitor 219 for reuse. This feature improves the vehicle's overall energy efficiency and reduces fuel consumption. The wireless power transmission system ensures that the vehicle's components receive a continuous and efficient power supply, enhancing the vehicle's reliability and performance.

In the case of an autonomous agricultural robot, the vehicle 200 is designed to perform tasks such as planting, harvesting, and monitoring crops. The vehicle 200 can navigate through fields and adjust its speed and direction based on driving parameters and the specific requirements of the agricultural tasks. The decentralized power generation and transmission system ensures that the vehicle 200 operates efficiently, reducing the need for frequent maintenance and increasing the overall productivity of agricultural operations. The adaptive suspension system allows the vehicle 200 to traverse uneven terrain smoothly, ensuring that the crops are not damaged during the process. The electronic control system 211 incorporates machine learning algorithms to optimize the vehicle's performance based on real-time data and feedback from various sensors, enhancing the overall efficiency and effectiveness of agricultural tasks.

While the foregoing is directed to embodiments of the present disclosure, other and further embodiments of the present disclosure may be devised without departing from the basic scope thereof, and the scope thereof is determined by the claims that follow.

What is claimed is:

1. A method for providing decentralized power generation and transmission for a vehicle having a plurality of robotic wheel assemblies, each robotic wheel assembly comprising an electronic control system and a wheel, the method comprising:
receiving an operational command for the vehicle;
identifying a desired movement of the wheel of one or more of the plurality of robotic wheel assemblies;
transmitting power, via a wireless power transmission system, from a vehicle battery to each of the one or more of the plurality of robotic wheel assemblies;
transmitting a command to an electronic control system of the one or more of the plurality of robotic wheel assemblies to instruct the electronic control system to perform the desired movement; and
monitoring, via one or more sensors, a movement of the vehicle.

2. The method of claim 1, wherein the wireless power transmission system utilizes inductive coupling to transmit power from the vehicle battery to the robotic wheel assemblies.

3. The method of claim 1, wherein the wireless power transmission system utilizes magnetic resonance to transmit power from the vehicle battery to the robotic wheel assemblies.

4. The method of claim 1, further comprising validating an identifier of each robotic wheel assembly before transmitting power to the robotic wheel assembly.

5. The method of claim 1, wherein the electronic control system of each of the plurality of robotic wheel assemblies is configured to adjust the rotation speed and direction of the wheel based on the received command.

6. The method of claim 1, wherein the sensors used to monitor the movement of the vehicle include accelerometers, gyroscopes, and position sensors.

7. The method of claim 1, wherein the electronic control system of each robotic wheel assembly incorporates machine learning algorithms to optimize control based on real-time data and feedback.

8. A vehicle having decentralized power generation and transmission systems, the vehicle comprising:
a vehicle electronic control system configured to control an operation of the vehicle;
a vehicle battery;
a plurality of robotic wheel assemblies, each robotic wheel assembly comprising:
a wheel;
an electronic control system configured to control a movement of the wheel;
a power transmission system configured to receive power wirelessly from the vehicle battery;
a sensor configured to provide real-time data to the electronic control system regarding the movement and position of the wheel; and
a communications module configured to enable data exchange between the electronic control system and the vehicle electronic control system;
a battery management system configured to manage a supply of power between the vehicle and the plurality of robotic wheel assemblies; and
a wireless power transmission system configured to transmit power wirelessly between the vehicle and the plurality of robotic wheel assemblies.

9. The vehicle of claim 8, wherein the wireless power transmission system utilizes inductive coupling to transmit power from the vehicle battery to the robotic wheel assemblies.

10. The vehicle of claim 8, wherein the wireless power transmission system utilizes magnetic resonance to transmit power from the vehicle battery to the robotic wheel assemblies.

11. The vehicle of claim 8, wherein the vehicle electronic control system is configured to validate an identifier of each of the plurality of robotic wheel assemblies before power is transmitted to the robotic wheel assembly.

12. The vehicle of claim 8, wherein the electronic control system of each of the plurality of robotic wheel assemblies is configured to adjust a rotational speed and direction of the wheel based on commands received from the vehicle electronic control system.

13. The vehicle of claim 8, further comprising vehicle sensors that are configured to monitor the movement of the vehicle, wherein the vehicle sensors include accelerometers, gyroscopes, and position sensors.

14. The vehicle of claim 8, wherein the electronic control system of each robotic wheel assembly incorporates machine learning algorithms to optimize control based on real-time data and feedback.

15. The vehicle of claim 8, wherein each of the plurality of robotic wheel assemblies further comprises a regenerative braking system configured to capture kinetic energy during braking and convert the kinetic energy into electrical energy.

16. The vehicle of claim 15, wherein each of the plurality of robotic wheel assemblies further comprises a capacitor configured to store the electrical energy captured by the regenerative braking system.

17. The vehicle of claim 15, wherein the electrical energy captured by the regenerative braking system is wirelessly transmitted to the vehicle battery.

18. The vehicle of claim 15, wherein the vehicle electronic control system is configured to coordinate and independently control an operation of each of the plurality of robotic wheel assemblies.

19. The vehicle of claim 15, wherein each of the plurality of robotic wheel assemblies further comprises a suspension system that includes an adaptive component that is controlled by the electronic control system.

20. A computer program product for providing decentralized power generation and transmission for a vehicle having a plurality of robotic wheel assemblies, each robotic wheel assembly comprising an electronic control system and a wheel, the computer program product comprising:
a set of one or more computer-readable storage media;
program instructions, collectively stored in the set of one or more storage media, for causing a processor set to perform the following computer operations:
receiving an operational command for the vehicle;
identifying a desired movement of the wheel of one or more of the plurality of robotic wheel assemblies;
transmitting power, via a wireless power transmission system, from a vehicle battery to each of the one or more of the plurality of robotic wheel assemblies;
transmitting a command to an electronic control system of the one or more of the plurality of robotic wheel assemblies to instruct the electronic control system to perform the desired movement; and
monitoring, via one or more sensors, a movement of the vehicle.
